(19) United States
(12) Patent Application Publication
(10) Pub. No.: US 2010/0186761 A1
(43) Pub. Date: Jul. 29, 2010

(54) ARTIFICIAL NAIL AND MANUFACTURING METHOD THEREOF

(76) Inventor: Sung Yong Chang, Roslyn Heights, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/691,878

(22) Filed: Jan. 22, 2010

(30) Foreign Application Priority Data
Jan. 23, 2009 (KR) 10-2009-0005807

(51) Int. Cl. A45D 29/00; B29C 45/00; C04B 41/45

(52) U.S. Cl. 132/73; 264/328.1; 264/132

(57) ABSTRACT

An artificial nail is provided. The artificial nail comprises a nail body. The nail body has indicating portions formed in the widthwise direction thereof. The indicating portions have a different surface roughness from the other portions. The indicating portions serve as guidelines when a user cuts the nail body attached to his/her nail to a desired length. Therefore, the indicating portions allow the user to easily cut the nail body to a desired shape while being in harmony with the length of other artificial nails. Further provided is a method for manufacturing the artificial nail.

### CROSS REFERENCE TO RELATED APPLICATIONS

This application claims the benefit under 35 U.S.C. §119(a) of Korean Patent Application Serial No. 10-2009-0005807, filed Jan. 23, 2009, which is incorporated herein by reference in its entirety.

### BACKGROUND OF THE INVENTION

1. Field of the Invention

The present invention relates to an artificial nail and a method for manufacturing the artificial nail. More particularly, the present invention relates to an artificial nail comprising a nail body wherein the nail body has indicating portions formed in the widthwise direction thereof and having a different surface roughness from the other portions.

2. Description of the Related Art

Many artificial tip nails are known. For example, Korean Patent No. 452280 proposes an artificial tip nail 10 made of a transparent plastic material and including a tip nail base 11, as illustrated in FIGS. 1 and 2. In the artificial tip nail 10, a decorative layer 12 is formed on the upper surface of the tip nail base 11 by using suitable means, such as an air brush. The tip nail base 11 is colored white to exhibit the same effect as when a French-style manicure is applied thereto.

The artificial tip nail 10 has an adhesive portion 13 at a tip thereof. The adhesive portion 13 is smaller in thickness than the tip nail base 11. A transparent adhesive is applied to the adhesive portion 13 to attach the artificial tip nail 10 to the tip of a natural nail 18.

The artificial tip nail 10 is adhered from the tip of the natural nail 18 to a predetermined position of the upper surface 14 of the natural nail 18 to produce a natural appearance. A filler 16 made of a transparent acrylic material is applied to the upper surface 14 of the natural nail, to which the artificial tip nail 10 is attached, to form a smooth surface with the artificial tip nail 10. A coating layer 17 made of a transparent acrylic material may be formed on the entire surface of the natural nail and the artificial tip nail to make the decorative layer 12 more decorative while creating an attractive appearance.

The artificial tip nail 10 is preferably made of an ABS resin. A user can cut the artificial tip nail 10 to a size and a shape as desired or can trim the artificial tip nail 10 by using a nail file. Even when the artificial tip nail 10 is attached to the natural nail, the user can see the inherent color of the underlying natural nail through the transparent artificial tip nail 10. That is, the artificial tip nail 10 forms a beautiful and natural appearance with the natural nail.

However, since no member or portion for guiding a cutting tool to the position of the artificial tip nail 10 to be cut by a user is provided in the artificial tip nail 10, he/she suffers from difficulty in cutting the artificial tip nail 10 to a desired length and shape. Further, there is a problem that the length of the artificial tip nail 10 remaining after cutting may not be in harmony with the length of other artificial tip nails. Thus, the artificial tip nail 10 will need to be handled by a nail artist.

### SUMMARY OF THE INVENTION

The present invention has been made in view of the above problems, and it is an object of the present invention to provide an artificial nail that can be easily cut to a shape as a user desires while being in harmony with the length of other artificial nails.

It is another object of the present invention to provide a method for manufacturing the artificial nail.

According to an aspect of the present invention, there is provided an artificial nail comprising a nail body wherein the nail body has indicating portions formed in the widthwise direction thereof and having a different surface roughness from the other portions.

In an embodiment, the indicating portions may be formed on the upper surface of the nail body and may be spaced apart from each other in the lengthwise direction of the nail body; and the nail body may have a latching step in the widthwise direction on the lower surface thereof.

According to another aspect of the present invention, there is provided a method for manufacturing an artificial nail, comprising shaping a nail body by molding and post-processing the nail body wherein indicating portions having a different surface roughness from the other portions are formed in the widthwise direction of the nail body in either the molding or the post processing step.

In an embodiment, the indicating portions may be formed by injection molding.

In an embodiment, the indicating portions may be formed using a mold having partially etched portions or by printing or spraying after injection molding so as to have a different surface roughness from the other portions.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a state in which a conventional artificial tip nail is attached to a natural nail without a filler and a coating layer;

FIG. 2 is a cross-sectional view illustrating a state in which a filler is applied to the upper surface of the artificial tip nail of FIG. 1;

FIG. 3 is a plan view of an artificial nail according to a preferred embodiment of the present invention;

FIG. 4 is a plan view illustrating a portion of the artificial nail of FIG. 3 remaining after cutting;

FIG. 5 is a plan view illustrating the artificial nail of FIG. 4 after coating;

FIG. 6 is a cross-sectional view illustrating a state in which the artificial nail of FIG. 4 is in use;

FIG. 7 illustrates a cross-sectional view and an enlarged partial view of an artificial nail according to another embodiment of the present invention; and

FIG. 8 is a plan view of the artificial nail of FIG. 7.

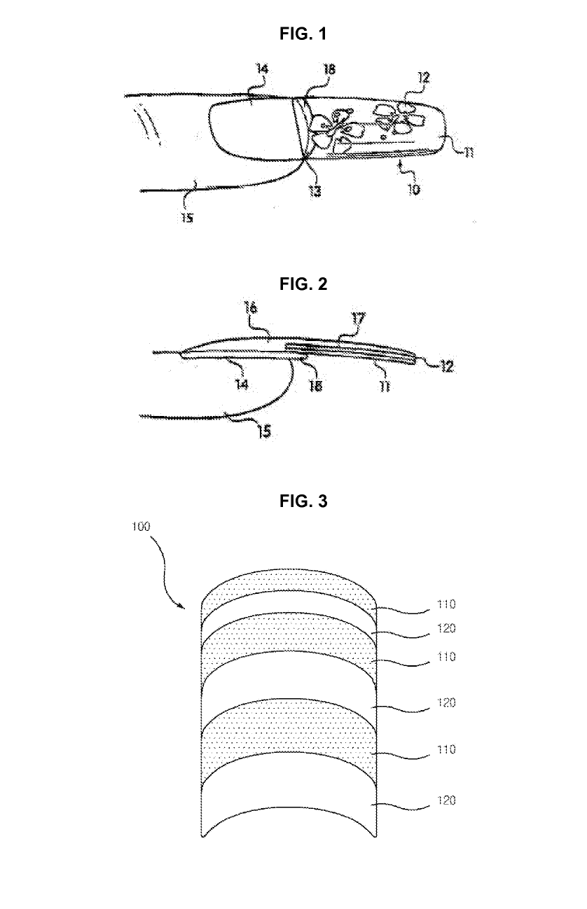

### DETAILED DESCRIPTION OF THE INVENTION

Preferred embodiments of the present invention will now be described in detail with reference to the accompanying drawings.

Note that the same reference numerals are given to elements having the same functions as the elements of the prior art artificial tip nail, and detailed descriptions thereof are omitted.

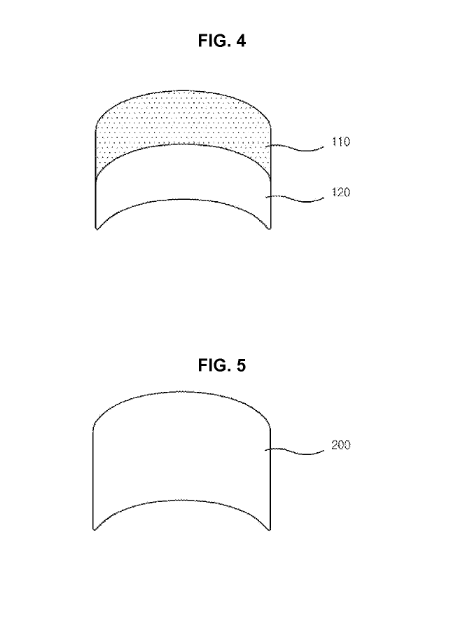

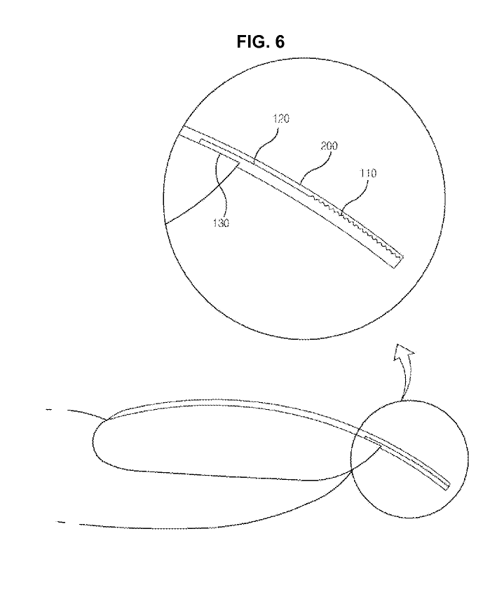

FIG. 3 is a plan view of an artificial nail according to a preferred embodiment of the present invention, FIG. 4 is a plan view illustrating a portion of the artificial nail of FIG. 3 remaining after cutting, FIG. 5 is a plan view illustrating the artificial nail of FIG. 4 after coating, and FIG. 6 is a cross-sectional view illustrating a state in which the artificial nail of FIG. 4 is in use.

As illustrated in FIGS. 3 through 6, the artificial nail comprises a nail body 100. Indicating portions 110 are formed in the widthwise direction of the nail body 100. The indicating portions 110 have a different surface roughness from the other portions 120 of the nail body 100.

As illustrated in FIG. 3, the nail body 100 is curved so as to protrude upward similarly to the shape of a man's nail.

The nail body 100 has a first end in contact with the tip of a user's nail and a second end opposite to the first end. The first end is more in the form of a circular arc than the second end. Due to this structure, the nail body 100 looks natural when it is attached to the natural nail.

The different surface roughnesses allow the indicating portions 110 to reflect and refract light in different modes from the other portions 120 of the nail body 100. This permits the user to easily visually discern the indicating portions 110 and the other portions 120.

The indicating portions 110 are in the form of circular arcs, like the first and second ends of the nail body 100. Due to this shape, the appearance of the nail body 100 after cutting looks natural.

The indicating portions 110 are formed on the upper surface of the nail body 110. This configuration enables the user to easily see the indicating portions 110.

As illustrated in FIGS. 5 and 6, a transparent coating layer 200 is formed on the upper surface of the nail body 100. The thickness of the coating layer 200 substantially prevents light from being refracted at the indicating portions 110, making the indicating portions 110 invisible as viewed from the outside of the nail body 100.

The indicating portions 110 can be made invisible by forming an opaque (i.e. a colored) coating layer or treating an acrylic material on the upper surface of the nail body 100.

The indicating portions 110 are spaced from each other along the length of the nail body 110. This arrangement enables the user to easily cut the nail body 100 to various lengths.

As illustrated in FIG. 6, a latching step 130 is formed in the widthwise direction on the lower surface of the nail body 100.

When the nail body 100 is attached to the user's nail, the latching step 130 prevents the upper surface of the nail body 100 from excessively protruding from his/her nail. In addition, the latching step 130 serves to determine the location of the natural nail where the nail body 100 is to be attached, facilitating attachment of the artificial nail to the nail body 100.

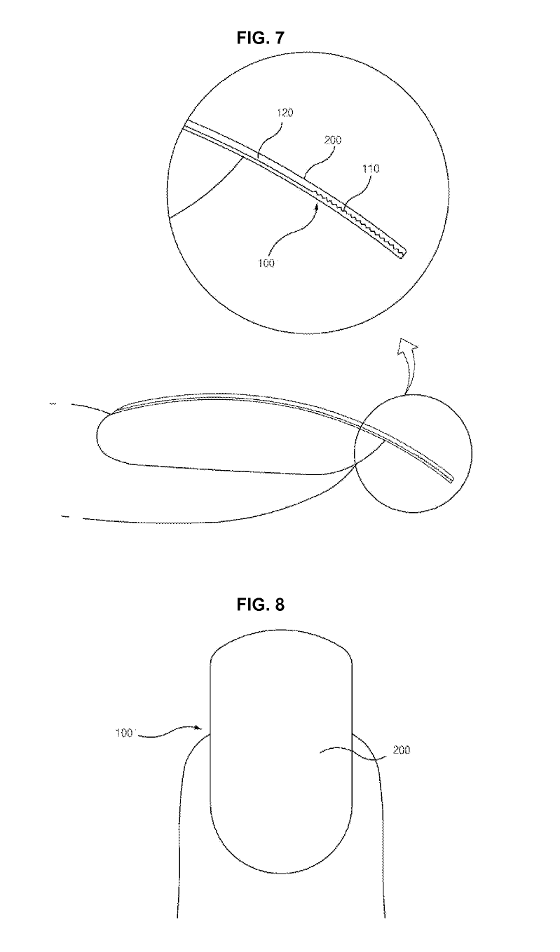

FIG. 7 illustrates a cross-sectional view of an artificial nail according to another embodiment of the present invention, and FIG. 8 is a plan view of the artificial nail of FIG. 7.

As illustrated in FIGS. 7 and 8, the artificial nail comprises a nail body 100′. The artificial nail has the same constitution as the artificial nail according to the previous embodiment except that the nail body 100′ covers the entire surface of a natural nail. The nail body 100′ of full cover type has a flat lower surface on which the latching step 130 is not formed. The indicating portions 110 are not formed at a portion of the nail body 100′ close to the root of the natural nail. Instead, the indicating portions 110 are formed from a portion of the nail body 100′ adjacent to the tip of the natural nail.

The indicating portions 110 serve as guidelines when the user cuts the nail body 110 attached to his/her nail to a desired length. Therefore, the indicating portions 110 allow the user to easily cut the nail body 100 to a desired shape along a borderline of one of the indicating portions 110 while being in harmony with the length of other artificial nails.

A description of a method for manufacturing the tip- or full cover-type artificial nail will be provided below.

In an embodiment, the method comprises shaping a nail body 100 or 100′ by molding and post-processing the nail body 100 or 100′. Indicating portions 110 are formed in the widthwise direction of the nail body 100 or 100′. The indicating portions 110 may be formed in the molding step and by printing or spraying in the post processing step so as to have a surface roughness different from the surface roughness of the other portions 120.

The molding is carried out by injection molding. The artificial nail of tip type has a latching step 130 formed on the lower surface thereof, whereas the artificial nail of full cover type has a flat lower surface.

A mold for the injection molding of the nail body 100 or 100′ is partially etched. The use of the partially etched mold makes the gloss, surface roughness and pattern of the indicating portions 110 different from those of the other portions 120.

In this way, the nail body 100 or 100′ formed with the indicating portions 110 can be shaped without the need for additional processing. In addition, the use of the partially etched mold is advantageous in that the surface roughness of the indicating portions 110 can be finely adjusted.

In an alternative embodiment, the indicating portions 110 may be formed by post processing of the injection-molded nail body 100 or 100′. The artificial nail of tip type has a latching step 130 formed on the lower surface thereof, whereas the artificial nail of full cover type has a flat lower surface.

Specifically, the indicating portions 110 may be formed by printing or spraying after the injection molding so as to have a different surface roughness from the other portions. In this step, an ink or paint containing bulky solid particles may be printed or sprayed on the injection-molded nail body 100 or 100′. As a result of the post processing, the gloss, surface roughness and pattern of the indicating portions 110 become different from those of the other portions 120. The surface roughness of the indicating portions 110 can be finely adjusted depending on the size of the solid particles used during the printing or spraying.

While the present invention has been described in detail with reference to the preferred embodiments, those skilled in the art will appreciate that various changes and modifications can be made thereto without departing from the spirit and scope of the present invention as set forth in the appended claims.

As described above, the method of the present invention can be applied to the manufacture of a tip nail that is attached only to the tip of a user's nail and a full cover artificial nail covering the entire surface of a user's nail.

As is apparent from the above description, the present invention has the following advantageous effects.

The artificial nail of the present invention can be cut to a desired length in a state in which the artificial nail is attached to a user's natural nail. The artificial nail may be attached to the tip of the natural nail (“tip type”) or may be attached so as to cover the entire surface of the natural nail (“full cover type”). The indicating portions serve as guidelines to allow the user to easily cut the artificial nail to a desired shape while adjusting the length of the artificial nail to the length of other artificial nails. Consequently, the user can directly attach the tip type or full cover type artificial nail to a natural nail without the help of a nail artist, and he/she can quickly cut the artificial nail.

The user can see the indicating portions formed on the upper surface of the nail body without difficulty. A coating layer may be formed on the upper surface of the nail body to make the indicating portions invisible in appearance.

The indicating portions are spaced apart from each other in the lengthwise of the nail body to allow the user to easily cut the artificial nail to various lengths.

A latching step is formed in the widthwise direction on the lower surface thereof. When the artificial nail is attached to the tip of the user's nail, the latching step prevents the artificial nail from excessively protruding from his/her nail. In addition, the latching step serves to determine the location of the natural nail where the artificial nail is to be attached, facilitating attachment of the artificial nail to the natural nail.

The indicating portions may be formed using a mold having partially etched portions without the need for subsequent processing. Alternatively, the indicating portions may be formed by printing or spraying in the post processing step. In this way, the surface roughness of the indicating portions can be finely adjusted.

What is claimed is:

1. An artificial nail comprising a nail body wherein the nail body has indicating portions formed in the widthwise direction thereof and having a different surface roughness from the other portions.

2. The artificial nail of claim 1, wherein the indicating portions are formed on the upper surface of the nail body and are spaced apart from each other in the lengthwise direction of the nail body.

3. The artificial nail of claim 1, wherein the nail body has a latching step in the widthwise direction on the lower surface thereof.

4. A method for manufacturing an artificial nail, comprising shaping a nail body by molding wherein indicating portions having a different surface roughness from the other portions are formed in the widthwise direction of the nail body.

5. The method of claim 4, wherein the nail body is shaped by injection molding and the indicating portions are formed using a partially etched mold.

6. A method for manufacturing an artificial nail, comprising shaping a nail body by molding and post-processing the nail body wherein indicating portions having a different surface roughness from the other portions are formed in the widthwise direction of the nail body in the molding step.

7. The method of claim 6, wherein the nail body is shaped by injection molding and the indicating portions are formed by printing or spraying an ink or paint containing solid particles on the injection-molded nail body.
